(19) United States
(12) Patent Application Publication
(10) Pub. No.: US 2002/0032594 A1
(43) Pub. Date: Mar. 14, 2002

(54) Method and system for providing network home delivery service, and storage medium storing a program for executing the method

(75) Inventor: Yasuhisa Fukuda, Tokyo (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: NEC LOGISTICS, LTD.

(21) Appl. No.: 09/899,988

(22) Filed: Jul. 9, 2001

(30) Foreign Application Priority Data
Jul. 12, 2000 (JP) P2000-211869

(51) Int. Cl. G06F 17/60

(52) U.S. Cl. 705/8

(57) ABSTRACT

In order to improve CS for both senders and receivers as customers and provide an efficient home delivery service, the delivery service provider receives an order of home delivery from the sender via the communication network and collects a relevant parcel. The delivery service provider sends information about the parcel to the receiver via the communication network, requests the receiver to designate a desired delivery time period, and then delivers the parcel during the designated time period.

### BACKGROUND OF THE INVENTION

Field of the Invention

The present invention relates to a method and system for providing network home delivery service, and to a storage medium storing a program for executing the method.

Description of the Related Art

In conventional home delivery services, the service is active after a sender transports a parcel to a shop dealing with the service, and the sender fills out a delivery slip. Such parcels received from each sender are collected and delivered by a delivery service provider who makes regular rounds of the shops. A receiver is not informed, in advance, of the delivery of a parcel; that is, only the sender can obtain information relating to the parcel, and the receiver can designate a desired delivery time only after delivery of the parcel has been attempted during the receiver's absence.

Therefore, in conventional home delivery services, each sender must fill out a delivery slip and transport a parcel to a shop which deals with the service. On the other hand, each receiver is not informed, in advance, of information about the parcel; thus, the receiver must cope with an unanticipated delivery. In addition, each shop must deal with the weighing and checking of each parcel, and receipt of the fee charged for the parcel. Furthermore, the delivery service provider must attempt to deliver the parcel again if the receiver is absent. Accordingly, the conventional systems are not always efficient.

### SUMMARY OF THE INVENTION

In consideration of the above circumstances, an object of the present invention is to provide a method and system for providing network home delivery service, and a storage medium storing a program for executing the method, for improving customer satisfaction (CS) for both senders and receivers as customers, reducing burdens on the senders and receivers, reducing the costs relating to each shop, and reducing the absence rate of the receivers, thereby reducing the overall cost.

Therefore, the present invention provides a method for providing network home delivery service, used in a network home delivery service system in which terminals of a sender and a receiver who are both customers and a host computer of a delivery service provider are connected via a communication network, the method comprising the steps of:

receiving an order of home delivery from the sender via the communication network, and collecting a relevant parcel;

sending information about the parcel to the receiver via the communication network, and requesting the receiver to designate a desired delivery time period; and

delivering the parcel during the designated time period.

According to the method, the delivery service provider collects the parcel when receiving the order of home delivery from the sender via the communication network. The delivery service provider then sends information about the parcel to the receiver and requests the receiver to designate a desired delivery time period. Therefore, it is possible to improve CS for both senders and receivers as customers, reducing burdens on the senders and receivers, reducing the costs relating to each shop, and reducing the absence rate of the receivers, thereby reducing the overall cost.

The present invention also provides a network home delivery service system, comprising:

a sender's terminal to which a sender of a parcel inputs order data which includes data about a receiver of the parcel;

a host computer for:

receiving the order data via a communication network and instructing collection of the parcel;

sending the receiver information about the parcel via the communication network and requesting the receiver to designate a desired delivery time period; and

instructing delivery of the collected parcel during the designated time period; and

a receiver's terminal to which the receiver inputs the desired delivery time period, and

wherein the sender's terminal, the host computer, and the receiver's terminal are connected to each other via the communication network.

According to the system, the sender (i.e., customer) can designate a desired parcel collecting time period via the communication network by using the sender's terminal and sends the order, and the delivery service provider who receives the order can instruct collection of the parcel to a truck or the like via the host computer and send the receiver information about the parcel via the truck. The receiver can communicate a desired delivery time period by using the receiver's terminal and the delivery of the parcel is performed by a truck or the like via an instruction by the delivery service provider using the host computer. Therefore, the sender needs not transport the parcel to a shop which deals with the service and not fill out a delivery slip, thereby reducing burdens on the sender and improving CS for the sender. The costs of each shop can also be reduced. Additionally, the desired delivery time of the receiver is confirmed, thereby also improving CS for the receiver. The costs relating to the delivery service provider can also be reduced by reducing the absence rate of the receivers.

The present invention also provides a computer readable storage medium storing a network home delivery service program used in a network home delivery service system in which terminals of a sender and a receiver who are both customers and a host computer of a delivery service provider are connected via a communication network, the program comprising the steps of:

receiving order data from the sender of a parcel, where the order data consists of sender data and receiver data, each including at least a zip code, an address, and a name;

sending the receiver delivery information based on the order data and requesting the receiver to input a desired delivery time period of the parcel;

receiving the input desired delivery time period from the receiver; and

receiving a delivery completion notice about the parcel and sending delivery completion information to the sender.

Accordingly, the above-explained effects obtained by the method for providing network home delivery service can also be obtained by executing this network home delivery service program.

In the above program, the step of receiving order data may include:

requesting the sender to input a desired parcel collecting time period; and

setting a lead time, necessary for parcel collection, for each zip code, and scheduling parcel collection by calculating a shortest possible collection time based on the lead time and the current time.

Also in the above program, the step of receiving the input desired delivery time period may include:

setting a delivery lead time for each combination of the zip code of each collecting place and the zip code of each delivery place, and scheduling parcel delivery by calculating a shortest possible delivery time based on the delivery lead time and the current time.

According to these options, the sender's desire is reflected in determination of the parcel collecting time, and the receiver's desire is reflected in determination of the parcel delivery time. In addition, based on the input zip code, the lead time for parcel collection or delivery is determined, and the optimal time period is determined by calculating a shortest possible time for parcel collection or delivery based on the current time. Therefore, CS can be improved and an efficient system can be constructed.

According to the present invention, it is possible to obtain secondary effects such as reduction of cardboard boxes used by instead using parcel-delivery boxes, and the possibility of electronic settlement.

### BRIEF DESCRIPTION OF THE DRAWINGS

FIG. 1 is a diagram showing the system structure of a network home delivery service of an embodiment according to the present invention.

FIG. 2 is a block diagram showing the internal structure of the host computer 1 in FIG. 1.

FIG. 3 is a flowchart showing the operation flow performed when the method of providing the network home delivery service of the present embodiment is executed.

FIG. 4A is a flowchart of an order data sending process in the network home delivery service program, and FIGS. 4B to 4H are diagrams showing examples shown on the display of a terminal.

FIG. 5A is a flowchart of a customer data inputting process in the network home delivery service program, and FIGS. 5B to 5D are diagrams showing examples shown on the display of a terminal.

FIG. 6A is a flowchart of a parcel collecting place inputting process in the network home delivery service program, and FIGS. 6B to 6C are diagrams showing examples shown on the display of a terminal.

FIG. 7A is a flowchart of a scheduled delivery information sending process in the network home delivery service program, and FIG. 7B is a diagram showing an example shown on the display of a terminal.

FIG. 8A is a flowchart of a desired delivery time inputting process in the network home delivery service program, and FIGS. 8B to 8E are diagrams showing examples shown on the display of a terminal.

FIG. 9A is a flowchart of a customer data inputting process in the network home delivery service program, and FIG. 9B is a diagram showing an example shown on the display of a terminal.

FIG. 10A is a diagram for explaining the method of calculating the time necessary for parcel collection, while FIG. 10B is a diagram for explaining the method of calculating the time necessary for parcel delivery.

### DESCRIPTION OF THE PREFERRED EMBODIMENTS

Hereinafter, an embodiment according to the present invention will be explained in detail with reference to the drawings.

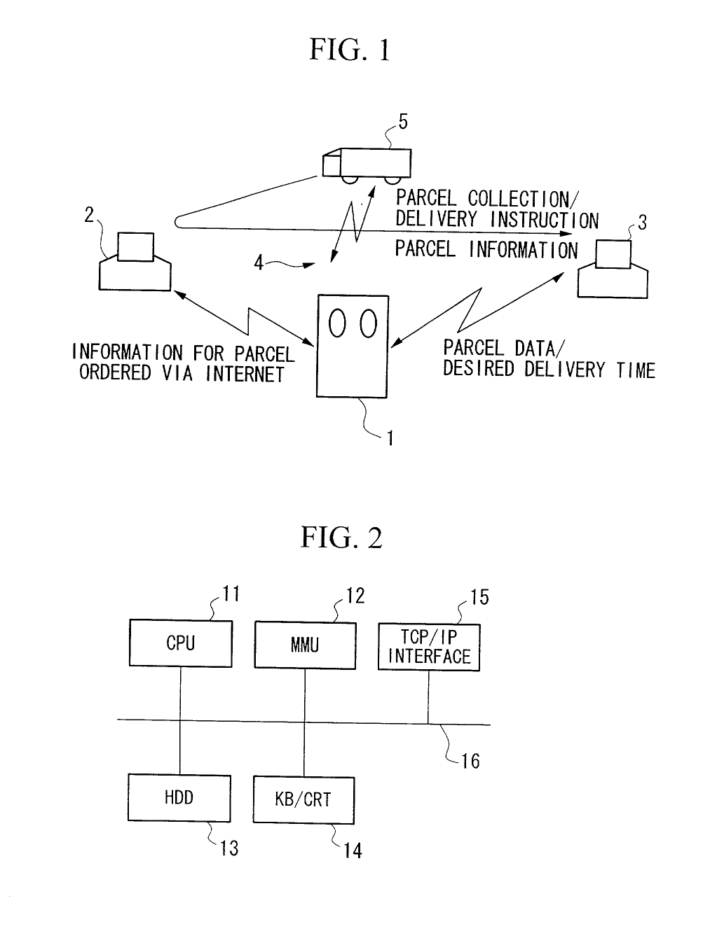

FIG. 1 is a diagram showing the system structure of a network home delivery service of the present embodiment. In the figure, reference numeral 1 indicates a host computer possessed by a delivery service provider of the present network home delivery service. Reference numeral 2 indicates a terminal (or personal computer) possessed by a sender as a customer of the present service, while reference numeral 3 indicates a terminal (or personal computer) possessed by a receiver as a customer of the present service. Here, each terminal may be a cellular phone or a PDA (personal digital assistant), and is connected via an Internet network 4 to the host computer.

Reference numeral 5 indicates a delivery medium, which is a truck in this case. The driver of the truck also has a cellular phone or a PHS (personal handy-phone system) which can be connected to the Internet so as to exchange data with the host computer 1.

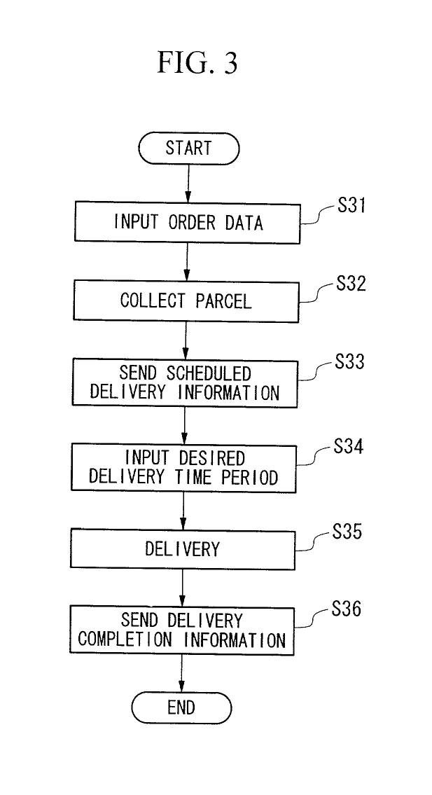

FIG. 2 is a block diagram showing the internal structure of the host computer 1 in FIG. 1.

The host computer 1 has a CPU 11 as a central control unit, and in the host computer 1, a main memory unit (MMU) 12, a large capacity storage device (HDD) 13, a keyboard and display unit (KB/CRT) 14, and a TCP/IP (transport control protocol/Internet protocol) interface 15 are connected with each other via a system bus 6 which includes address, data, and control lines.

The HDD 13 has a database storing customer data such as zip (or postal) codes, telephone numbers, addresses, names, and the like. As occasion demands, this database is referred to via a network home delivery service program loaded on the MMU 2. The TCP/IP interface 5 performs communication control for connecting the Internet network 4 and exchanging data.

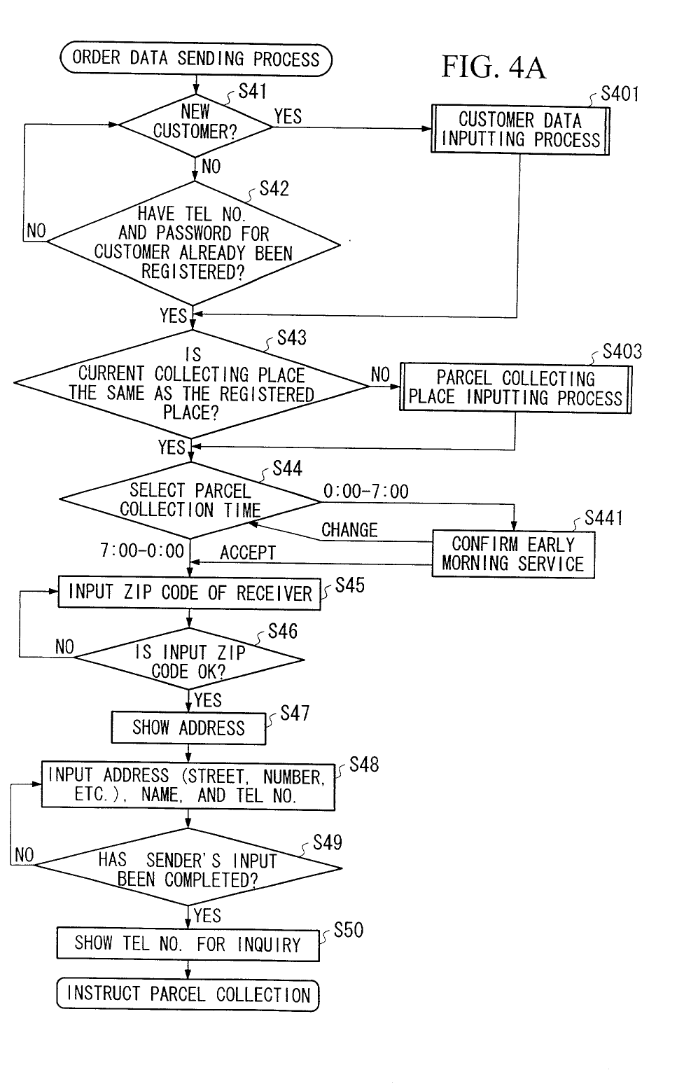

FIG. 3 is a flowchart showing the operation flow performed by a delivery service provider when the method of providing the network home delivery service of the present embodiment is executed.

In FIG. 3, when a sender inputs order data via the Internet network 4 (see step S31), the delivery service provider goes to the sender's place and receives the subject parcel by using a truck 5 or the like (see step S32), and then sends an e-mail (i.e., electronic mail) message including scheduled delivery information via the Internet network 4 to the appropriate receiver (see step S33).

The delivery service provider also requests the receiver to input a desired delivery time period (see step S34). After the receiver inputs a desired delivery time period, the delivery service provider delivers the relevant parcel in the designated time period (see step S35), and simultaneously, sends the sender an e-mail message including delivery completion information (see step S36).

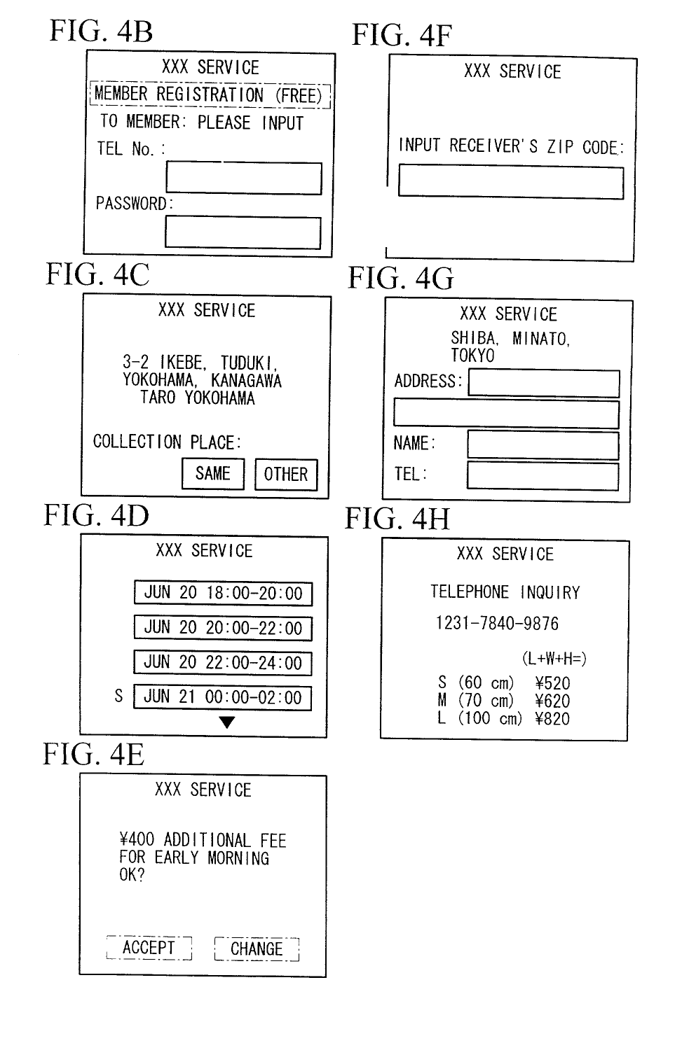

FIGS. 4A, 5A, 6A, 7A, 8A, and 9A are flowcharts respectively showing the following processes in the network home delivery service program: an order data sending process, a customer data inputting process, a parcel collecting place inputting process, a scheduled delivery information sending process, a desired delivery time inputting process, and a delivery completion information sending process.

FIGS. 4B to 4H, 5B to 5D, 6B to 6C, 7B, 8B to 8E, and 9B are examples shown on the display of terminal 2 or 3. These figures are provided for explaining the flowcharts. Here, each terminal is a cellular phone.

First, the order data sending process will be explained with reference to FIG. 4A. This process is performed using the terminal 2 of the sender, which is connected to the host computer 1 of the delivery service provider, so that data exchange is performed between the host computer 1 and the terminal 2. In this process, contents as shown in FIGS. 4B to 4H are shown on the display of the terminal 2, in turn.

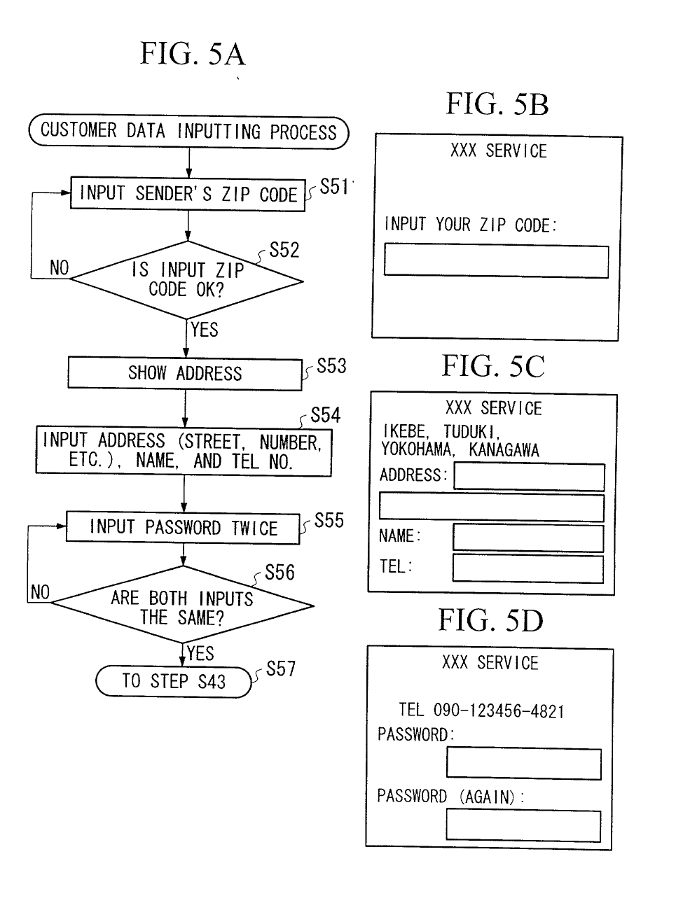

In the first step S41, it is determined whether the present customer is a new customer (refer to FIG. 4B). If the sender is a new customer, then the sender is requested to input the telephone number and name (of the sender), so that the sender is registered as a customer. The detailed explanation of the customer data inputting process (see step S401) will be explained below with reference to FIG. 5A.

If the present customer is not a new customer in step S41, then, it is determined whether the telephone number and the password with respect to the customer have already been registered (see step S42). If the result of the determination is “NO”, the operation returns to step S41, while if the result of determination is “YES”, then data registered with respect to the customer is confirmed (see step S43).

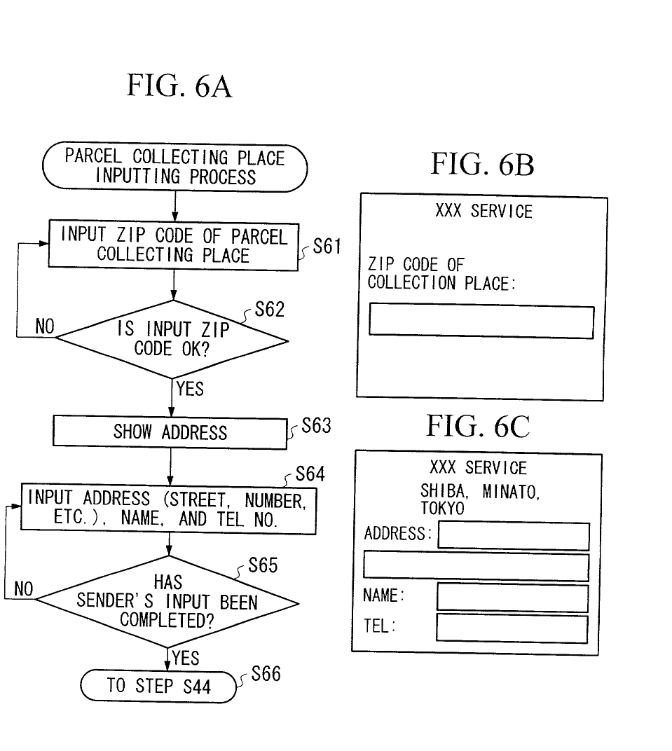

If the desired place of collecting a current parcel (i.e., current collecting place) differs from the registered place, the button “OTHER” is clicked on the display (see FIG. 4C), so that the parcel collecting place inputting process shown in FIG. 6A is executed. If the current collecting place is the same as the registered place, the button “SAME” is clicked on the display, so that the parcel collection time is selected (see step S44).

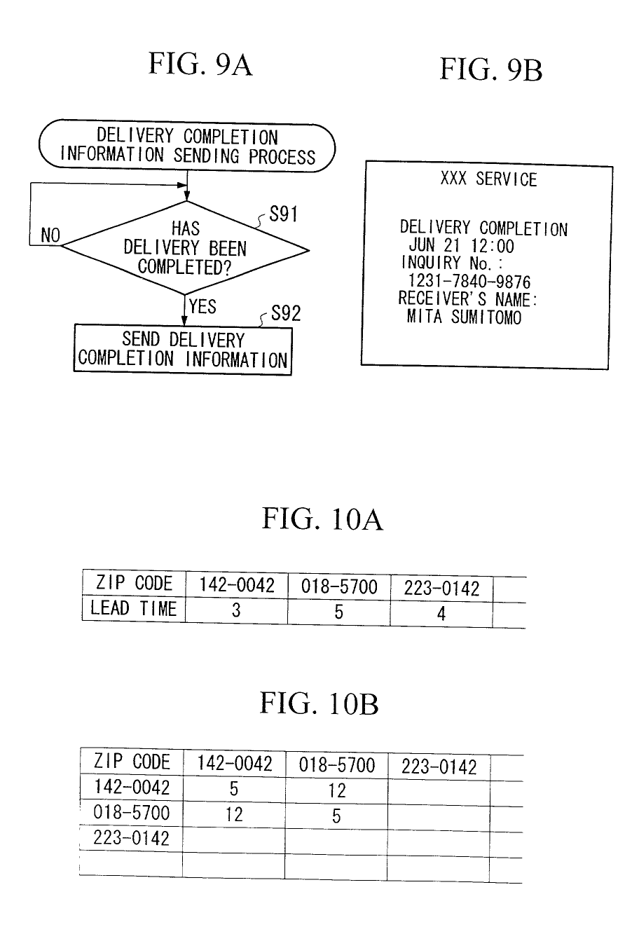

In the selection, possible time periods in the service are shown (see FIG. 4D), and the sender selects a desired one among the shown time periods. In order to set possible time periods in the service, a lead time necessary for collecting parcels is determined for each zip code, as shown in FIG. 10A, and the shortest time for collecting parcels is calculated with reference to the current time and the set lead time.

If the sender selects early morning service (0:00-7:00), the contents of the service is confirmed (see step S441 and FIG. 4E), and if the sender does not accept the contents, the sender can correct the selected data, that is, select again.

In the next step S45, the sender is requested to input the zip code of the receiver (see FIG. 4F). When the zip code is input, the input zip code is confirmed (see step S46). If the input zip code is suitable, the address portion corresponding to the zip code is shown on the display (see step S47 and FIG. 4G), and the sender is requested to input the remaining address portion such as a street, number, the name, and the telephone number (see step S48 and FIG. 4G).

Next, it is confirmed that the sender's input has been completed (see step S49), and in the following step S50, the telephone number for inquiries is shown on the display (see FIG. 4H), and then an instruction for collecting the parcel is issued.

Below, the customer data inputting process (see the above step S401) as shown in FIG. 5A will be explained.

In the first step S51, the sender is requested to input the zip code (of the sender, see FIG. 5B). The input zip code is confirmed and the corresponding address portion is shown on the display (see steps S52 and S53). In the following step S54, the sender is requested to input the remaining address portion such as a street, number, the name, and the telephone number (see step S54 and FIG. 5C), and is further requested to input a password (see step S55 and Fig. SD). The password is checked, and if it is determined that the input password is valid, then the operation jumps to step S43 where the registered data is confirmed.

In the parcel collecting place inputting process shown in FIG. 6A, in the first step S61, the sender is requested to input the zip code of a desired parcel collecting place (see FIG. 6B). The input zip code is then confirmed (see step S62), and the address portion corresponding to the confirmed zip code is shown (see step S63 and FIG. 6C). In the following step S64, the sender is requested to input the remaining address portion such as a street, number, the name, and the telephone number (see FIG. 6C). In the next step S65, the completion of sender's inputting operation is confirmed, and the process is returned to step S44 in FIG. 4A for selecting the parcel collection time.

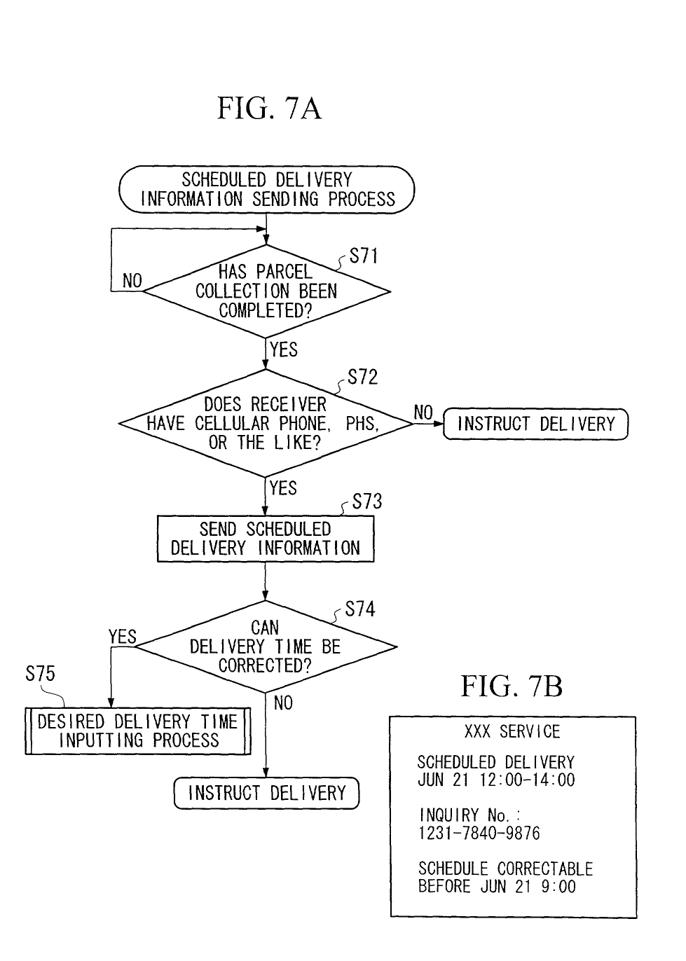

In the scheduled delivery information sending process in FIG. 7A, in the first step S71, the completion of the parcel collection is confirmed, and then scheduled delivery information is sent to the relevant customer (i.e., receiver) if the customer has a cellular phone, a personal handy-phone system (PHS), or the like (see steps S72 and S73).

FIG. 7B shows an example of the scheduled delivery information shown on the display of such a cellular phone or PHS. The scheduled delivery information is determined by setting a delivery lead time for each combination of the zip code of each collecting place and the zip code of each delivery place (corresponding to the receiver's address), as shown in FIG. 10B, and calculating the shortest possible delivery time.

In addition, the limit time for correcting the scheduled delivery time is also shown on the display, as shown in FIG. 7B. If a request for correcting the scheduled delivery time is sent from the receiver before the limit time, the request is accepted and then a delivery instruction is issued (see steps S74 and S75).

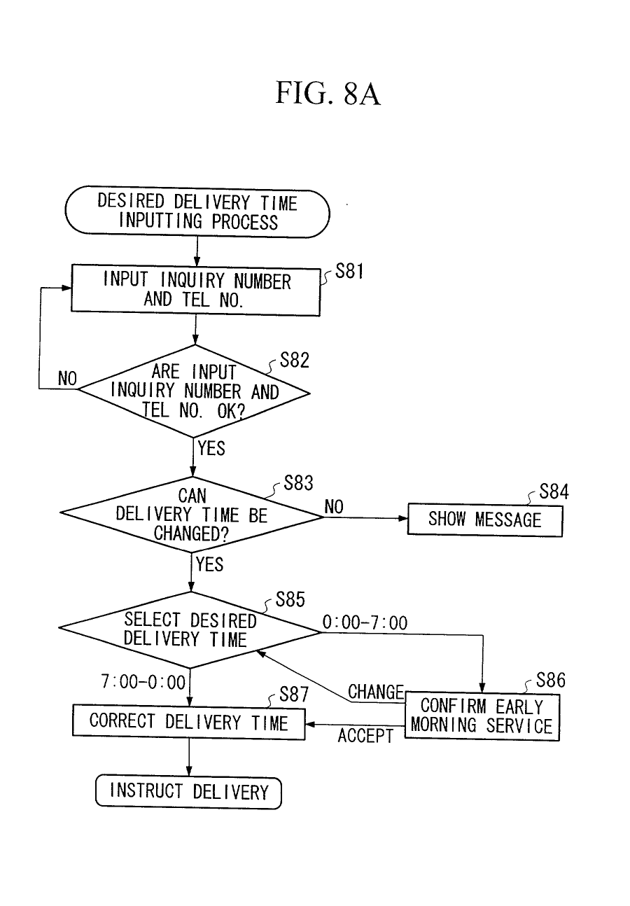

In the desired delivery time inputting process in FIG. 8A, in the first step S81, the receiver is requested to input the inquiry number (refer to FIG. 7B) and the telephone number (of the receiver) (see FIG. 8B). The input data is confirmed (see step S82), and then it is determined whether the current delivery time can be changed (see step S83).

If the delivery time cannot be changed, a message communicating that the delivery instruction has already been issued and no change can be accepted is shown on the display of the receiver's terminal (see step S84 and FIG. 8C). If the delivery time can be changed, a desired time period is selected (see step S85 and FIG. 8D). In the present embodiment, the time period from 0:00 to 7:00 requires an additional fee, and in this case, this condition is confirmed (see step S86 and FIG. 8E). After the confirmation, the delivery time is corrected (see step S87). If the receiver selects another time period, the delivery time is immediately corrected (see step S87).

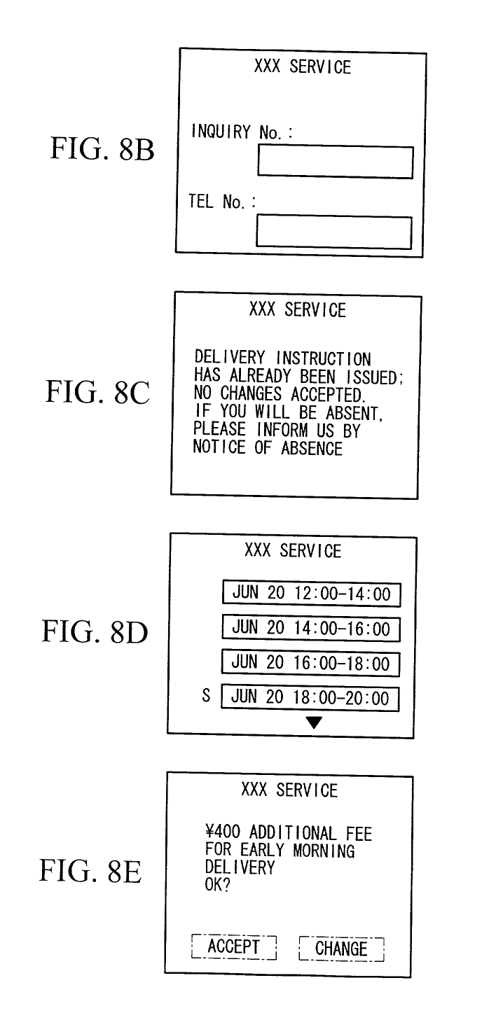

In the delivery completion information sending process as shown in FIG. 9A, the completion of the delivery is confirmed (see step S91), and delivery completion information addressed to the relevant sender and receiver is sent, so that when the terminal 2 or 3 receives the information, a message as shown in FIG. 9B, including delivery completion time (i.e., date and hour), the inquiry number, and the receiver's name, is shown on the display.

What is claimed is:

1. A method for providing network home delivery service, used in a network home delivery service system in which terminals of a sender and a receiver who are both customers and a host computer of a delivery service provider are connected via a communication network, the method comprising the steps of:
receiving an order of home delivery from the sender via the communication network, and collecting a relevant parcel;
sending information about the parcel to the receiver via the communication network, and requesting the receiver to designate a desired delivery time period; and
delivering the parcel during the designated time period.

2. A network home delivery service system, comprising:
a sender's terminal to which a sender of a parcel inputs order data which includes data about a receiver of the parcel;
a host computer for:
receiving the order data via a communication network and instructing collection of the parcel;
sending the receiver information about the parcel via the communication network and requesting the receiver to designate a desired delivery time period; and
instructing delivery of the collected parcel during the designated time period; and
a receiver's terminal to which the receiver inputs the desired delivery time period, and
wherein the sender's terminal, the host computer, and the receiver's terminal are connected to each other via the communication network.

3. A computer readable storage medium storing a network home delivery service program used in a network home delivery service system in which terminals of a sender and a receiver who are both customers and a host computer of a delivery service provider are connected via a communication network, the program comprising the steps of:
receiving order data from the sender of a parcel, where the order data consists of sender data and receiver data, each including at least a zip code, an address, and a name;
sending the receiver delivery information based on the order data and requesting the receiver to input a desired delivery time period of the parcel;
receiving the input desired delivery time period from the receiver; and
receiving a delivery completion notice about the parcel and sending delivery completion information to the sender.

4. A computer readable storage medium as claimed in claim 3, wherein the step of receiving order data includes:
requesting the sender to input a desired parcel collecting time period; and
setting a lead time, necessary for parcel collection, for each zip code, and scheduling parcel collection by calculating a shortest possible collection time based on the lead time and the current time.

5. A computer readable storage medium as claimed in claim 3, wherein the step of receiving the input desired delivery time period includes:
setting a delivery lead time for each combination of the zip code of each collecting place and the zip code of each delivery place, and scheduling parcel delivery by calculating a shortest possible delivery time based on the delivery lead time and the current time.
